(19) United States
(12) Patent Application Publication
(10) Pub. No.: US 2024/0317948 A1
(43) Pub. Date: Sep. 26, 2024

(54) POLYAMIDE-LONG GLASS FIBER REINFORCED COMPOSITE MATERIAL AND METHOD FOR PRODUCING THE SAME

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHUN-LAI CHEN, TAIPEI (TW)

(21) Appl. No.: 18/347,539

(22) Filed: Jul. 5, 2023

(30) Foreign Application Priority Data
Mar. 25, 2023 (TW) 112111300

(51) Int. Cl. C08J 5/04; C08K 5/092

(52) U.S. Cl. CPC C08J 5/043; C08K 5/092; C08J 2377/10; C08J 2423/00

(57) ABSTRACT

A polyamide-long glass fiber reinforced composite material and a method for producing the same are respectively provided. The composite material includes an impregnating material and a glass fiber material. The impregnating material includes a polyamide resin, a toughener, and a compatibilizer. The toughener is an elastomer composed of a first polyolefin material and modified by maleic anhydride. The compatibilizer is a resin material composed of a second polyolefin material and modified by the maleic anhydride. A first melt flow index of the toughener is less than a second melt flow index of the compatibilizer. The glass fiber material is impregnated and covered by the impregnating material. The glass fiber material includes a long glass fiber, and a surface of the long glass fiber is modified by at least one of a hydroxyl group and a carboxyl group.

### CROSS-REFERENCE TO RELATED PATENT APPLICATION

This application claims the benefit of priority to Taiwan Patent Application No. 112111300, filed on Mar. 25, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polymer composite material, and more particularly to a polyamide-long glass fiber reinforced composite material and a method for producing the same.

### BACKGROUND OF THE DISCLOSURE

A molecular structure of a polyamide resin (i.e., nylon plastic) has a large amount of hydrophilic amide groups. The polyamide resin has poor mechanical properties, such as poor toughness or abrasion resistance. Therefore, application fields of the polyamide resin are relatively limited. To address the above issues, processes such as copolymerization, blending and toughening, and reinforcement are often used in the industry to modify the polyamide resin. The process of glass fiber reinforcement is a modification method commonly used in the polyamide resin to effectively enhance abrasion resistance, mechanical strength, hardness, and dimensional stability of the polyamide resin.

With the increase of a length of a glass fiber, a reinforcement effect of the glass fiber on the polyamide resin is significantly improved. Compared with a short glass fiber, the most notable feature of a long glass fiber reinforcement material is that impact strength can be doubled in the long glass fiber reinforcement material. A polyamide-long glass fiber reinforced composite material has advantages such as high strength, high rigidity, high notched impact strength, short-term heat resistance, and fatigue resistance. In addition, the polyamide-long glass fiber reinforced composite material can maintain good mechanical properties in a high temperature and a high humidity environment, and can replace metals as structural materials.

However, in the related art, the polyamide-long glass fiber reinforced composite material still has poor toughness, and an impregnating effect of the polyamide resin on the long glass fiber during a manufacturing process is still poor, leaving significant room for improvement.

### SUMMARY OF THE DISCLOSURE

In response to the above-referenced technical inadequacies, the present disclosure provides a polyamide-long glass fiber reinforced composite material and a method for producing the same.

In one aspect, the present disclosure provides a method for producing a polyamide-long glass fiber reinforced composite material. The method includes: performing a feeding step, an impregnating step, and a shaping step. The feeding step includes feeding raw materials into an extruder, and mixing and melting the raw materials to form a mixed plastic melt. The raw materials include a polyamide resin, a toughener, and a compatibilizer. The toughener is an elastomer composed of a first polyolefin material and modified by maleic anhydride, the compatibilizer is a resin material composed of a second polyolefin material and modified by the maleic anhydride, and a first melt flow index of the toughener is less than a second melt flow index of the compatibilizer. The impregnating step includes conveying the mixed plastic melt into an impregnating device; and conveying a long glass fiber in a continuous form into the impregnating device, so that the long glass fiber is fully impregnated by the mixed plastic melt. A surface of the long glass fiber is modified by at least one of a hydroxyl group and a carboxyl group. The shaping step includes shaping, cooling, and pelletizing the long glass fiber impregnated by the mixed plastic melt to obtain the polyamide-long glass fiber reinforced composite material.

In certain embodiments, the extruder is a twin-screw extruder, a processing temperature of the extruder is between 250° C. and 400° C., and a screw rotation speed of the extruder is between 200 rpm and 300 rpm.

In certain embodiments, the first polyolefin material of the toughener is at least one material selected from the group consisting of ethylene-propylene diene monomer (EPDM) rubber, thermoplastic polyolefin (TPO), polyolefin elastomer (POE), and ethylene-methyl acrylate-glycidyl methacrylate (E-MA-GMA) terpolymer.

In certain embodiments, a first maleic anhydride graft ratio of the toughener is between 0.3% and 1.5%, and the first melt flow index of the toughener is between 1 g/10 min and 20 g/10 min.

In certain embodiments, the second polyolefin material of the compatibilizer is at least one material selected from the group consisting of polyethylene (PE), polypropylene (PP), and ethylene-propylene copolymer.

In certain embodiments, a second maleic anhydride graft ratio of the compatibilizer is between 0.3% and 1.5%, and the second melt flow index of the toughener is between 100 g/10 min and 600 g/10 min.

In certain embodiments, when the toughener, the compatibilizer, and the polyamide resin are mixed and melted in the extruder, an active anhydride group of the maleic anhydride modified on the toughener or the compatibilizer is capable of reacting with an amino functional group at an end of a polymer chain of the polyamide resin to initially form an amide bond, and then form an imide bond after a ring-closing reaction, so that a graft copolymer is finally formed.

In certain embodiments, the raw materials further include a flow modifier, and the flow modifier is a polyolefin type hyper-dispersant having a number average molecular weight between 1,000 g/mol and 10,000 g/mol.

In certain embodiments, in the impregnating step, the long glass fiber is conveyed to a spreading device through a bobbin device, and the long glass fiber is introduced into the impregnating device after a preheating operation and a spreading operation, so that the long glass fiber in a preheated and spread state is impregnated by the mixed plastic melt.

In certain embodiments, the long glass fiber impregnated by the mixed plastic melt is capable of being outputted from the impregnating device after being bundled and covered by a die head of the impregnating device. The long glass fiber is a glass fiber having a length between 5 millimeters and 30 millimeters.

In another aspect, the present disclosure provides a polyamide-long glass fiber reinforced composite material that includes an impregnating material and a glass fiber material. The impregnating material includes a polyamide resin, a toughener, and a compatibilizer. The toughener is an elastomer composed of a first polyolefin material and modified by maleic anhydride. The compatibilizer is a resin material composed of a second polyolefin material and modified by the maleic anhydride. A first melt flow index of the toughener is less than a second melt flow index of the compatibilizer. The glass fiber material is impregnated and covered by the impregnating material. The glass fiber material includes a long glass fiber, and a surface of the long glass fiber is modified by at least one of a hydroxyl group and a carboxyl group.

In certain embodiments, the first polyolefin material of the toughener is at least one material selected from the group consisting of ethylene-propylene diene monomer (EPDM) rubber, thermoplastic polyolefin (TPO), polyolefin elastomer (POE), and ethylene-methyl acrylate-glycidyl methacrylate (E-MA-GMA) terpolymer. A first maleic anhydride graft ratio of the toughener is between 0.3% and 1.5%, and the first melt flow index of the toughener is between 1 g/10 min and 20 g/10 min.

In certain embodiments, the second polyolefin material of the compatibilizer is at least one material selected from the group consisting of polyethylene (PE), polypropylene (PP), and ethylene-propylene copolymer. A second maleic anhydride graft ratio of the compatibilizer is between 0.3% and 1.5%, and the second melt flow index of the toughener is between 100 g/10 min and 600 g/10 min.

In certain embodiments, the impregnating material further incudes a flow modifier, and the flow modifier is a polyolefin type hyper-dispersant having a number average molecular weight between 1,000 g/mol and 10,000 g/mol.

In certain embodiments, based on a total weight of the impregnating material being 100 parts by weight, a content of the polyamide resin is between 50 parts by weight and 97 parts by weight, a content of the toughener is between 0.1 parts by weight and 20 parts by weight, a content of the compatibilizer is between 0.1 parts by weight and 20 parts by weight, and a content of the flow modifier is not greater than 10 parts by weight.

In certain embodiments, a weight ratio between the glass fiber material and the impregnating material ranges from 5:95 to 65:35.

Therefore, in the polyamide-long glass fiber reinforced composite material and the method for producing the same provided by the present disclosure, by virtue of “the toughener being an elastomer composed of a first polyolefin material and modified by maleic anhydride, the compatibilizer being a resin material composed of a second polyolefin material and modified by the maleic anhydride, and a first melt flow index of the toughener being less than a second melt flow index of the compatibilizer,” and “the long glass fiber being fully impregnated by the mixed plastic melt, and a surface of the long glass fiber being modified by at least one of a hydroxyl group and a carboxyl group,” the toughness of the polyamide resin (i.e., nylon plastic) can be effectively improved, and the poor impregnating effect during the manufacturing process can also be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a polyamide-long glass fiber reinforced composite material according to an embodiment of the present disclosure; and

FIG. 2 is a schematic view showing a device used in the method for producing the polyamide-long glass fiber reinforced composite material according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [Method for Producing Reinforced Composite Material]

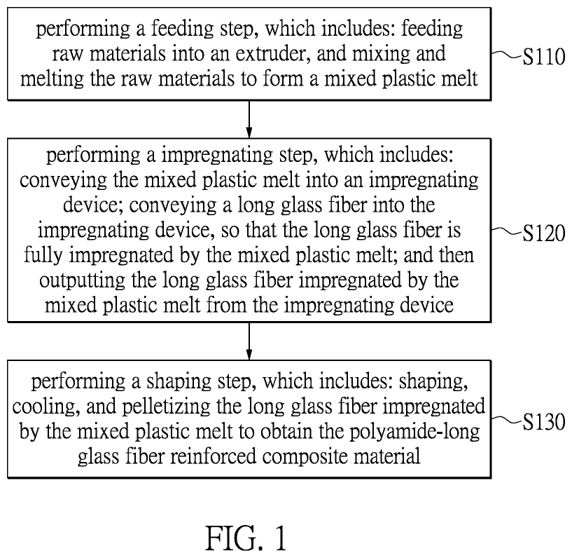

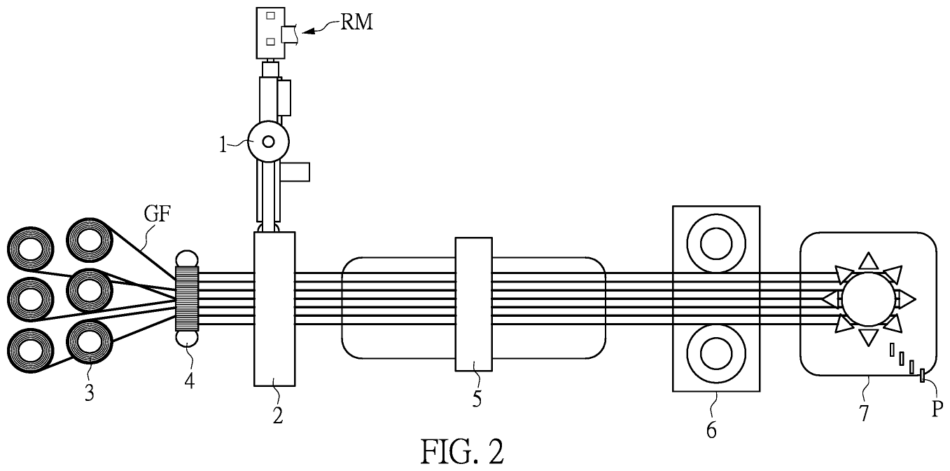

Referring to FIG. 1 and FIG. 2, an embodiment of the present disclosure provides a method for producing a polyamide-long glass fiber reinforced composite material. The method includes steps S110 to S130. It should be noted that, a sequence of steps and an actual operation described in this embodiment can be adjusted according to practical requirements, and the present disclosure is not limited to those described in this embodiment. The method disclosed in this embodiment of the present disclosure can include additional operations before, during, or after each step, and certain operations as described herein can be replaced, eliminated, or rearranged to achieve additional embodiments of the method.

The step S110 includes performing a feeding step. The feeding step includes feeding raw materials RM into an extruder 1, and mixing and melting the raw materials RM to form a mixed plastic melt. The raw materials RM at least include: a polyamide resin (PA resin), a toughener, a compatibilizer, and a flow modifier. By introducing the toughener into the polyamide resin, toughness of the plastic can be improved. In addition, by introducing the compatibilizer and the flow modifier into the polyamide resin, the toughener can have better compatibility with the polyamide resin. In addition, the raw materials RM can further include: an antioxidant, a slip agent, and a colorant.

In some embodiments of the present disclosure, the extruder 1 can be, for example, a twin screw extruder. A processing temperature of the extruder 1 can be controlled, for example, to be between 250° C. and 400° C., and preferably to be between 250° C. and 350° C., so that the polymer materials in the raw materials RM can be melted. It should be noted that the processing temperature mentioned herein refers to a temperature control of each section of the extruder 1 (i.e., a feeding section, a compression section, a melting section, a metering section, a machine head, and a die). Furthermore, the temperature control of each section of the components can be the same or different from each other, and the present disclosure is not limited thereto.

Furthermore, a screw rotation speed of the extruder 1 is controlled to be between 200 revolutions per minute (rpm) and 300 rpm, and preferably controlled to be between 240 rpm and 260 rpm, but the present disclosure is not limited thereto.

In the raw materials RM, the polyamide resin is also known as nylon resin. The polyamide resin is formed by polymerizing carboxyl group-containing monomers and amino group-containing monomers through amide bonds.

The toughener is an elastomer composed of a first polyolefin material. The first polyolefin material is at least one material selected from the group consisting of ethylene-propylene diene monomer (EPDM) rubber, thermoplastic polyolefin (TPO), polyolefin elastomer (POE), and ethylene-methyl acrylate-glycidyl methacrylate (E-MA-GMA) terpolymer.

The ethylene-propylene diene monomer (EPDM) rubber is an elastomer and is a synthetic rubber. EPDM is a copolymer of ethylene and propylene, or a ter-polymer of ethylene, propylene, and a small amount of a third monomer, such as diene. The thermoplastic polyolefin (TPO) is an elastomer. TPO is a blend of ethylene-propylene monomer (EPM) rubber or ethylene-propylene-diene (EPDM) rubber with an olefin-based material, such as polyethylene (PE) and/or polypropylene (PP). In other words, TPO is a rubber-plastic blend. The polyolefin elastomer (POE) is an elastomer, and POE is a material based on ethylene and/or propylene. Specifically, POE refers to a polymer synthesized by adding monomers such as 1-butene or 1-octene during the polymerization of ethylene and/or propylene, and the molecular structure of POE is similar to that of the ethylene-propylene-diene (EPDM).

Although chemical structures or properties of the abovementioned four materials (EPDM, TPO, POE, E-MA-GMA) are similar to each other, the four materials are still slightly different from each other by definition. For those skilled in the art of the present disclosure, it can be understood that the four materials should be material types of the same level, rather than material types with upper and lower levels. In addition, the elastomer referred to herein is a viscoelastic polymer having a low Young's modulus and a high failure strain.

Furthermore, in the present embodiment, the toughener is preferably a material modified by maleic anhydride (MAH). The maleic anhydride can be, for example, grafted onto the toughener (i.e., the elastomer composed of the first polyolefin material) so as to modify the toughener. More specifically, the maleic anhydride can be, for example, modified onto the toughener by melt grafting. The melt grafting can be, for example, performed in a single screw extruder, a twin screw extruder, or a rheometer, and is preferably performed in the twin screw extruder.

In some embodiments of the present disclosure, a first maleic anhydride graft ratio of the maleic anhydride grafted onto the toughener is preferably between 0.3% and 1.5%, and more preferably between 0.5% and 1.3%.

It should be noted that the “maleic anhydride graft ratio” referred to herein can be analyzed by using Fourier-transform infrared spectroscopy (FTIR). The Fourier-transform infrared spectroscopy can qualitatively analyze whether or not the maleic anhydride is grafted onto a molecular chain of a polyolefin material, and can quantify a graft ratio of the maleic anhydride. It can be seen from an infrared spectrum that a maleic anhydride grafted material has obvious absorption peaks at 1780 cm⁻¹ and 1830 cm⁻¹, and the absorption peaks are the characteristic peaks of carboxyl groups in the maleic anhydride. In addition, a quantitative analysis of the graft ratio of the maleic anhydride can be performed, for example, according to the Beer-Lambert law.

Furthermore, in some embodiments of the present disclosure, the toughener has a first melt flow index (MI), and the first melt flow index is preferably between 1 g/10 min and 20 g/10 min, and more preferably between 3 g/10 min and 15 g/10 min.

It should be noted that the “melt flow index (MI)” referred to herein refers to a weight of a polyolefin material passing through a standard die every 10 minutes on a melt flow velocimeter, and the unit of the melt flow index is g/10 min. The melt flow index represents the fluidity of a resin material in a molten state. The larger the melt index is, the smaller the molecular weight of the resin material is, and the better the fluidity of the resin material is. Conversely, the larger the molecular weight of the resin material is, the more difficult it is for the molecular chain to move; further, the smaller the melt flow index is, the worse the fluidity of the resin material is. In the present embodiment, the melt flow index is measured according to ASTM D1238 under the conditions of 230° C. and a load of 2.16 kg.

The compatibilizer is a resin material composed of a second polyolefin material. The second polyolefin material is at least one material selected from the group consisting of polyethylene (PE), polypropylene (PP), and ethylene-propylene copolymer. The compatibilizer is a polyolefin material modified by maleic anhydride (MAH). For example, the compatibilizer can be maleic anhydride-modified polyethylene, maleic anhydride-modified polypropylene, or maleic anhydride-modified ethylene-propylene copolymer. It is worth mentioning that, the compatibilizer is the polyolefin material and is not an elastomer. The compatibilizer has a higher flow property (higher melt flow index) than the toughener in a molten state. In some embodiments of the present disclosure, a second maleic anhydride graft ratio of the maleic anhydride grafted onto the compatibilizer is preferably between 0.3% and 1.5%, and more preferably between 0.5% and 1.3%.

Furthermore, the compatibilizer has a second melt flow index, and the second melt flow index is preferably between 100 g/10 min and 600 g/10 min, and more preferably between 200 g/10 min and 500 g/10 min.

The method of grafting the maleic anhydride onto a polyolefin material and the definitions of the graft ratio and the melt flow index have been described above, and will not be reiterated herein.

It is worth mentioning that, in the embodiment of the present disclosure, the toughener is a polyolefin material modified by the maleic anhydride, and the compatibilizer is another polyolefin material modified by the maleic anhydride. Accordingly, when the toughener, the compatibilizer, and the polyamide resin (PA resin) are mixed with each other and melted in the extruder, an active anhydride group (i.e., an organic acid anhydride) of the maleic anhydride modified on the toughener or the compatibilizer is capable of reacting with an amino functional group at an end of a polymer chain of the polyamide resin to initially form an amide bond (—NH—CO—), and then form an imide bond (—N—(C═O)₂) after a ring-closing reaction. Therefore, a graft copolymer of the toughener, the compatibilizer, and the polyamide resin (i.e., toughener/compatibilizer-g-PA copolymer) is finally formed.

Therefore, the graft copolymer located on phase interfaces can enhance a cohesive force between the phase interfaces through covalent bonds, thereby expanding a distribution range of a dispersion phase (i.e., the toughener and the compatibilizer) in a continuous phase (i.e., the polyamide resin), so that the performances (i.e., toughness and low temperature impact resistance) of the graft copolymer can be more significantly improved.

Furthermore, the flow modifier is a hyper-dispersant (i.e., a polymer dispersant), which is a high-efficiency polymer dispersant having a number average molecular weight between 1,000 and 10,000. More specifically, the flow modifier is a polyolefin type hyper-dispersant. In one embodiment of the present disclosure, the flow modifier is Solplus™ hyper-dispersant, which is a 100% active polymeric dispersant that can improve dispersion and stability of fillers in a thermoplastic, but the present disclosure is not limited thereto.

The introduction of the flow modifier can improve on the lack of fluidity of the polyolefin material in a molten state, so that the mixed plastic melt can have a better impregnating effect on a glass fiber material.

In addition, the antioxidant is an antioxidant for the polyamide resin. More specifically, the antioxidant is at least one material selected from the group consisting of pentaerythrityl tetrakis(3,5-di-tert-butyl-4-hydroxy-phenyl)propionate, tris(2,4-di-tert-butylphenyl)phosphite, and octadecyl 3-(3,5-di-tert-butyl-4-hydroxyphenyl)propionate. Further, the antioxidant is preferably pentaerythrityl tetrakis(3,5-di-tert-butyl-4-hydroxy-phenyl)propionate, but the present disclosure is not limited thereto. The slip agent is a slip agent for the polyamide resin, and is at least one material selected from the group consisting of ethylene-bis-stearamide (EBS), erucamide, polyethylene wax, paraffin wax, stearic acid, zinc stearate, and calcium stearate. Further, the slip agent is preferably ethylene-bis-stearamide (EBS), but the present disclosure is not limited thereto. Further, the colorant is used to enable a polymer material to have color. The colorant is at least one of titanium dioxide, carbon black, and other inorganic or organic colorants. Further, the colorant is preferably titanium dioxide, but the present disclosure is not limited thereto. Since the above-mentioned antioxidant, slip agent, and colorant are applications of related art, these materials will not be reiterated herein.

In terms of content range, based on a total weight of the raw materials RM being 100 parts by weight, a content of the polyamide resin is preferably in a range of from 50 parts by weight to 97 parts by weight, and more preferably in a range of from 75 parts by weight to 96 parts by weight. A content of the toughener is preferably in a range of from 0.1 parts by weight to 20 parts by weight, and more preferably in a range of from 4 parts by weight to 20 parts by weight. A content of the compatibilizer is preferably in a range of from 0.1 parts by weight to 20 parts by weight, and more preferably in a range of from 3 parts by weight to 15 parts by weight. A content of the flow modifier is preferably not greater than 10 parts by weight, and more preferably in a range of from 2 parts by weight to 5 parts by weight. A content of the antioxidant is preferably in a range of from 0.1 parts by weight to 3 parts by weight, and more preferably in a range of from 0.1 parts by weight to 1.5 parts by weight. A content of the slip agent is preferably in a range of from 0.01 parts by weight to 3 parts by weight, and more preferably in a range of from 0.1 parts by weight to 1.5 parts by weight. In addition, a content of the colorant is preferably in a range of from 0.5 parts by weight to 5 parts by weight, and more preferably in a range of from 1 part by weight to 2 parts by weight.

The step S120 includes performing an impregnating step. The impregnating step includes conveying the mixed plastic melt formed from the step S110 into an impregnating device 2; conveying a long glass fiber GF that is in a continuous form into the impregnating device 2, so that the long glass fiber GF is fully impregnated by the mixed plastic melt; and then outputting the long glass fiber GF impregnated by the mixed plastic melt from the impregnating device 2.

More specifically, the long glass fiber GF is conveyed to a spreading device 4 through a bobbin device 3, and the long glass fiber GF is introduced into the impregnating device 2 after a preheating operation (e.g., the preheating operation has preheating temperatures of between 110° C. and 130° C.) and a spreading operation, so that the long glass fiber GF that is in preheated and spread states is impregnated by the mixed plastic melt. After the impregnating process is completed, the long glass fiber GF impregnated by the mixed plastic melt is capable of being outputted from the impregnating device 2 after being bundled and covered by a bell-shaped die head of the impregnating device 2. It should be noted that the long glass fiber GF is defined as a glass fiber having a length of between 5 millimeters (mm) and 30 mm, and preferably between 6 mm and 25 mm.

In some embodiments of the present disclosure, a weight ratio of the long glass fiber(s) GF to the mixed plastic melt (i.e., the impregnating material) ranges from 5:95 to 65:35, and preferably ranges from 40:60 to 60:40, so that the long glass fiber(s) GF has a better impregnating effect.

In addition, a surface of the long glass fiber GF is preferably modified by a functional group, such as a hydroxyl group (—OH) and/or a carboxyl group (—COOH). For example, the surface of the long glass fiber GF can be treated by a silane coupling agent to have the above-mentioned functional group, but the present disclosure is not limited thereto. Accordingly, when the long glass fiber GF is impregnated by the mixed plastic melt, the maleic anhydride-modified toughener and the maleic anhydride-modified compatibilizer in the mixed plastic melt can interact with the hydroxyl group and/or the carboxyl group on the surface of the long glass fiber GF. Therefore, a degree of impregnation of the long glass fiber GF by the mixed plastic melt can be effectively improved.

It is worth mentioning that if the toughener or the compatibilizer is not modified by the maleic anhydride, materials such as EPDM, TPO, POE, PP, and PE have poor compatibility with the polyamide (PA) resin, so that a phenomenon of two-phase separation may occur. Furthermore, when the toughener or the compatibilizer that is not modified by maleic anhydride is mixed with the glass fiber, the glass fiber may break at the die of the impregnating device 2, and fiber blockage may occur at an extrusion port of the impregnating device 2.

The step S130 includes performing a shaping step. The shaping step includes shaping and cooling the above-mentioned long glass fiber GF impregnated by the mixed plastic melt through a shaping device 5 with a cooling temperature of between 15° C. and 35° C.

The shaping step further includes guiding the long glass fiber GF impregnated by the mixed plastic melt to a pelletizing device 7 through a guiding device 6 for a pelletizing operation, so as to obtain a pelletized product P of polyamide-long glass fiber reinforced composite material.

### [Polyamide-Long Glass Fiber Reinforced Composite Material]

The above embodiment describes in detail the method for producing the polyamide-long glass fiber reinforced composite material. Another embodiment of the present disclosure further provides a polyamide-long glass fiber reinforced composite material that can be formed by the above method, but the present disclosure is not limited thereto.

Specifically, the polyamide-long glass fiber reinforced composite material includes: an impregnating material and a glass fiber material, and the glass fiber material is impregnated and covered by the impregnating material.

The impregnating material includes: a polyamide resin, a toughener, a compatibilizer, a flow modifier, an antioxidant, a slip agent, and a colorant. That is, the material composition of the impregnating material corresponds to the raw materials RM in the above-mentioned method for producing the polyamide-long glass fiber reinforced composite material.

The polyamide resin can be, for example, a nylon resin. The toughener is an elastomer composed of a first polyolefin material, and the first polyolefin material is at least one material selected from the group consisting of ethylene-propylene diene monomer (EPDM) rubber, thermoplastic polyolefin (TPO), polyolefin elastomer (POE), and ethylene-methyl acrylate-glycidyl methacrylate (E-MA-GMA) terpolymer.

Furthermore, in the present embodiment, the toughener is preferably a material modified by maleic anhydride (MAH). The maleic anhydride can be, for example, grafted onto the toughener (i.e., the elastomer made of the first polyolefin material) so as to modify the toughener. In some embodiments of the present disclosure, a first maleic anhydride graft ratio of the maleic anhydride grafted onto the toughener is preferably between 0.3% and 1.5%, and more preferably between 0.5% and 1.3%. Furthermore, the toughener has a first melt flow index (MI), and the first melt flow index is preferably between 1 g/10 min and 20 g/10 min, and more preferably between 3 g/10 min and 15 g/10 min.

The compatibilizer is a resin material composed of a second polyolefin material. The second polyolefin material is at least one material selected from the group consisting of polyethylene (PE), polypropylene (PP), and ethylene-propylene copolymer. The compatibilizer is also a material modified by maleic anhydride. In some embodiments of the present disclosure, a second maleic anhydride graft ratio of the maleic anhydride grafted onto the compatibilizer is preferably between 0.3% and 1.5%, and more preferably between 0.5% and 1.3%. Furthermore, the compatibilizer has a second melt flow index, and the second melt flow index is preferably between 100 g/10 min and 600 g/10 min, and more preferably between 200 g/10 min and 500 g/10 min.

The flow modifier is a hyper-dispersant (i.e., a polymer dispersant), which is a high-efficiency polymer dispersant having a number average molecular weight (Mn) between 1,000 and 10,000. More specifically, the flow modifier is a polyolefin type hyper-dispersant. In one specific embodiment of the present disclosure, the flow modifier is Solplus™ hyper-dispersant, but the present disclosure is not limited thereto.

The material characteristics of the antioxidant, the slip agent, and the colorant have been described in the above-mentioned embodiment of the method and will not be reiterated herein.

In terms of content range, based on a total weight of the impregnating material that corresponds to the above-mentioned raw materials RM being 100 parts by weight, a content of the polyamide resin is preferably in a range of from 50 parts by weight to 97 parts by weight, and more preferably in a range of from 75 parts by weight to 96 parts by weight. A content of the toughener is preferably in a range of from 0.1 parts by weight to 20 parts by weight, and more preferably in a range of from 4 parts by weight to 20 parts by weight. A content of the compatibilizer is preferably in a range of from 0.1 parts by weight to 20 parts by weight, and more preferably in a range of from 3 parts by weight to 15 parts by weight. A content of the flow modifier is preferably not greater than 10 parts by weight, and more preferably in a range of from 2 parts by weight to 5 parts by weight. A content of the antioxidant is preferably in a range of from 0.1 parts by weight to 3 parts by weight, and more preferably in a range of from 0.1 parts by weight to 1.5 parts by weight. A content of the slip agent is preferably in a range of from 0.01 parts by weight to 3 parts by weight, and more preferably in a range of from 0.1 parts by weight to 1.5 parts by weight. In addition, a content of the colorant is preferably in a range of from 0.5 parts by weight to 5 parts by weight, and more preferably in a range of from 1 part by weight to 2 parts by weight.

Furthermore, the glass fiber material is composed of long glass fibers, and each of the long glass fibers is defined as a fiber having a length of between 5 millimeters (mm) and 30 mm, and preferably between 6 mm and 25 mm.

In some embodiments of the present disclosure, a weight ratio between the glass fiber material (i.e., the long glass fibers) and the impregnating material ranges from 5:95 to 65:35, and preferably ranges from 40:60 to 60:40. In addition, a surface of the long glass fiber is preferably modified by at least one of a hydroxyl functional group (—OH) and a carboxyl functional group (—COOH), so that the long glass fiber can have a better impregnating effect.

In terms of technical effects, the technical solution provided by the embodiment of the present disclosure is to first preheat and spread the glass fiber. Then, the polyamide resin (i.e., nylon plastic) is mixed with polymer modifiers, such as the toughener, the compatibilizer, and the flow modifier, and melted and plasticized by an extruder to form the mixed plastic melt. Finally, the mixed plastic melt is fed into an impregnating device to impregnate the glass fiber.

Through the technical solutions of the embodiment of the present disclosure, the melt viscosity of the mixed plastic melt can be controlled to be at a range suitable for impregnating the long glass fiber by using the modifier, so that the long glass fiber can be impregnated in the impregnating device, thereby preparing the polyamide-long glass fiber reinforced composite material. Furthermore, through the technical solutions of the embodiment of the present disclosure, the problem that the polyamide resin does not easily impregnate the glass fiber can be effectively addressed by the introduction of the toughener, the compatibilizer, and the flow modifier.

Furthermore, the embodiment of the present disclosure adopts the elastomer, such as EPDM, TPO or POE, to improve the toughness of the polyamide resin, especially under a low temperature condition (i.e., impact strength at a low temperature).

Furthermore, using the above elastomer to be grafted with maleic anhydride can successfully add low-temperature impact resistance of the elastomer to the polyamide resin. Moreover, the introduction of the flow modifier (i.e., an active solid polymer dispersant) of the embodiment of the present disclosure can improve the dispersion and stability of the discontinuous phases (i.e., the toughener, the slip agent, and the colorant) in the thermoplastic.

In addition, to improve an overall toughness of the polyamide-long glass fiber reinforced composite material, in the embodiment of the present disclosure, the toughener (i.e., EPDM, TPO, POE, or E-MA-GMA) grafted with maleic anhydride MA and the compatibilizer (i.e., PP, PE, or PP/PE) grafted with maleic anhydride MA are added into the polyamide resin, so as to form the polyamide-long glass fiber reinforced composite material. It is worth mentioning that, in the embodiment of the present disclosure, the first maleic anhydride graft ratio of the toughener is preferably between 0.3% and 1.5%, and the second maleic anhydride graft ratio of the compatibilizer is preferably between 0.3% and 1.5%. The technical effect of limiting the maleic anhydride graft ratios to the abovementioned ranges is to improve the compatibility between different resin materials and to improve the adhesion between the resin materials and the glass fibers. If the maleic anhydride graft ratio of the toughener or the compatibilizer is less than 0.3%, the compatibility between different resin materials is poor, and phase separation occurs, so that the physical property of the final product is poor. If the maleic anhydride graft ratio of the toughener or the compatibilizer is greater than 1.5%, the manufacturing cost is too high. Furthermore, the first melt flow index of the toughener is preferably between 1 g/10 min and 20 g/10 min, and the technical effect is that the toughener can effectively improve the toughness of the composite material within the range of the melt flow index. If the first melt flow index is less than 1 g/10 min, the fluidity of the mixed plastic melt is too low for the mixed plastic melt to be extruded. If the first melt flow index is greater than 20 g/10 min, the toughening effect of the toughener is not realized. The second melt flow index of the compatibilizer is preferably between 100 g/10 min and 600 g/10 min, and the technical effect is that the compatibilizer can improve the dispersibility of the toughener in the polyamide resin. If the second melt flow index is less than 100 g/10 min, the dispersibility of the toughener in the polyamide resin is poor. If the second melt flow index is greater than 600 g/10 min, the compatibility effect cannot be significantly improved.

According to the abovementioned configurations, the polyamide-long glass fiber reinforced composite material of the embodiment of the present disclosure can have excellent heat resistance, stiffness, mechanical strength, chemical resistance, and surface gloss, and can have low water absorption and good dimensional stability.

The polyamide-long glass fiber reinforced composite material of the embodiment of the present disclosure can be widely used in the fields of electronic appliances, automobiles, military industries, and the like.

### EXPERIMENTAL DATA AND EXPERIMENTAL RESULTS

To prove the technical effects of the polyamide-long glass fiber reinforced composite material and the method for producing the same of the present disclosure, experimental data and experimental results of the present disclosure will be described below. However, the following Exemplary Embodiments and Comparative Examples are only for the convenience of understanding the present disclosure, and the scope of the present disclosure is not limited thereto.

In Exemplary Embodiments 1 to 7, the raw materials as shown in Table 1 are fed into a twin-screw extruder, and the raw materials are mixed and melted to form a mixed plastic melt. Among them, the raw materials include: a polyamide resin, a toughener (i.e., POE-g-MA, TPO-g-MA, EPDM-g-MA, or E-MA-GMA-g-MA), a compatibilizer (i.e., PE-g-MA, PP-g-MA, or PE/PP-g-MA), a flow modifier (i.e., a polyolefin hyper-dispersant), and other additives (i.e., an antioxidant, a slip agent, and a colorant). Then, the mixed plastic melt is conveyed into an impregnating device, and at least a long glass fiber that is in a continuous form and having at least a hydroxyl group modified thereon is conveyed into the impregnating device, so that the long glass fiber(s) is fully impregnated by the mixed plastic melt. The long glass fiber(s) impregnated by the mixed plastic melt is shaped and cooled, and then pelletized to obtain a polyamide-long glass fiber reinforced composite material.

One of the differences between Comparative Examples 1 to 3 and the above-mentioned Exemplary Embodiments 1 to 7 is that the raw materials of Comparative Examples 1 to 3 only include the polyamide resin, the antioxidant, the slip agent, and the colorant, but do not include the toughener, the compatibilizer, and the flow modifier that are included in the raw materials of the Exemplary Embodiments 1 to 7.

Then, the polyamide-long glass fiber reinforced composite materials prepared in the above Exemplary Embodiments and Comparative Examples are subjected to tests such as tensile strength, elongation, bending strength, impact strength, heat distortion temperature, gloss, and water absorption. The tensile strength and the elongation are analyzed according to ISO 527. The bending strength is analyzed according to ISO 178. The impact strength CHARPY is analyzed according to ISO 179. The heat distortion temperature (HDT) is analyzed according to ISO 75. The gloss is analyzed by using a VG-7000 gloss meter on a surface of the sample. The water absorption conditions for the water absorption are a temperature of 23° C. and a relative humidity of 50%. The relevant test results are shown in Table 1.

TABLE 1

| | | Exem- | Exem- | Exem- | Exem- | Exem- | Exem- | Exem- | Compara- | Compara- | Compara- |
|---|---|---|---|---|---|---|---|---|---|---|---|
| | | plary | plary | plary | plary | plary | plary | plary | tive | tive | tive |
| | | Embodi- | Embodi- | Embodi- | Embodi- | Embodi- | Embodi- | Embodi- | Example | Example | Example |
| Items | | ment 1 | ment 2 | ment 3 | ment 4 | ment 5 | ment 6 | ment 7 | 1 | 2 | 3 |
| Raw | Amount of | 95.8 | 91.8 | 95.8 | 75.8 | 85.8 | 85.7 | 75.7 | 98.8 | 98.8 | 98.8 |
| materials | polyamide | | | | | | | | | | |
| fed into | resin (g) | | | | | | | | | | |
| the | Amount of | 5 | 4 | 10 | 20 | 5 | 5 | 5 | 0 | 0 | 0 |
| Extruder | toughener (g) | | | | | | | | | | |
| for melt | Material type | EPDM-g- | POE-g- | POE-g- | POE-g- | POE-g- | E-MA- | TPO-g- | — | — | — |
| mixing | of toughener | MA | MA | MA | MA | MA | GMA-g- | MA | | | |
| | | | | | | | MA | | | | |
| | Maleic | 0.3 | 1.2 | 0.6 | 0.7 | 0.7 | 0.7 | 0.5 | — | — | — |
| | anhydride | | | | | | | | | | |
| | (MA) graft | | | | | | | | | | |
| | ratio of | | | | | | | | | | |
| | toughener (%) | | | | | | | | | | |
| | Melt flow | 6 | 6 | 5 | 8 | 3 | 6 | 7 | — | — | — |
| | index (MI) of | | | | | | | | | | |
| | toughener | | | | | | | | | | |
| | (g/10 min) | | | | | | | | | | |
| | Amount of | 5 | 3 | 5 | 5 | 10 | 5 | 15 | 0 | 0 | 0 |
| | compatibilizer | | | | | | | | | | |
| | (g) | | | | | | | | | | |
| | Material | PE-g- | PE-g- | PP-g- | PP-g- | PE/PP-g- | PP-g- | PE-g- | — | — | — |
| | type of | MA | MA | MA | MA | MA | MA | MA | | | |
| | compatibilizer | | | | | | | | | | |
| | Maleic | 0.3 | 0.7 | 0.5 | 1.1 | 0.7 | 0.7 | 0.8 | — | — | — |
| | anhydride | | | | | | | | | | |
| | (MA) graft | | | | | | | | | | |
| | ratio of | | | | | | | | | | |
| | compatibilizer | | | | | | | | | | |
| | (%) | | | | | | | | | | |
| | Melt flow | 250 | 150 | 330 | 500 | 430 | 330 | 150 | — | — | — |
| | index (MI) of | | | | | | | | | | |
| | compatibilizer | | | | | | | | | | |
| | (g/10 min) | | | | | | | | | | |
| | Amount of | 3 | 3 | 3 | 3 | 3 | 3 | 3 | 0 | 0 | 0 |
| | flow modifier | | | | | | | | | | |
| | (g) | | | | | | | | | | |
| | Amount of | 0.20 | 0.20 | 0.20 | 0.20 | 0.20 | 0.20 | 0.20 | 0.20 | 0.20 | 0.20 |
| | antioxidant (g) | | | | | | | | | | |
| | Amount of slip | 0.05 | 0.05 | 0.05 | 0.05 | 0.05 | 0.1 | 0.1 | 0.05 | 0.05 | 0.05 |
| | agent (g) | | | | | | | | | | |
| | Amount of | 1 | 1 | 1 | 1 | 1 | 1 | 1 | 1 | 1 | 1 |
| | colorant (g) | | | | | | | | | | |
| Glass | Weight ratio of | 50/50 | 50/50 | 50/50 | 50/50 | 50/50 | 50/50 | 50/50 | 50/50 | 50/50 | 50/50 |
| fiber | glass fiber(s) | | | | | | | | | | |
| ratio | to raw | | | | | | | | | | |
| | materials | | | | | | | | | | |
| Test | Tensile | 207.4 | 205.5 | 257.0 | 180.1 | 207.0 | 190.6 | 210.6 | 178 | 204.0 | 198.1 |
| results | strength MPa | | | | | | | | | | |
| | (ISO 527) | | | | | | | | | | |
| | Elongation % | 3.4 | 3.6 | 2.5 | 2.7 | 3.0 | 2.5 | 2.8 | 2.3 | 1.9 | 1.9 |
| | (ISO 527) | | | | | | | | | | |
| | Bending | 317.0 | 333.3 | 372.4 | 268.6 | 278.0 | 352.8 | 276.5 | 279 | 340.1 | 311.4 |
| | strength MPa | | | | | | | | | | |
| | (ISO 178) | | | | | | | | | | |
| | CHARPY | 37.6 | 43.6 | 45.5 | 54.5 | 46.1 | 43.9 | 45.9 | 12.2 | 15.0 | 16.1 |
| | KJ/m²(23° C.) | | | | | | | | | | |
| | (ISO 179) | | | | | | | | | | |
| | CHARPY | 32.1 | 35.2 | 40.2 | 53.7 | 45.4 | 41.7 | 42.8 | 2.1 | 3.0 | 3.5 |
| | KJ/m² (−40° C.) | | | | | | | | | | |
| | (ISO 179) | | | | | | | | | | |
| | HDT ° C. | 215 | 215 | 255 | 255 | 235 | 235 | 215 | 215 | 255 | 235 |
| | (ISO 75) | | | | | | | | | | |
| | Gloss (%) | 85 | 86 | 86 | 85 | 87 | 82 | 83 | 53 | 48 | 52 |
| | Water | 1.3 | 1.3 | 1.1 | 1.1 | 1.2 | 1.2 | 1.3 | 1.6 | 1.3 | 1.4 |
| | absorption (%) | | | | | | | | | | |

### Results and Discussions

According to the above results, compared with Comparative Examples 1 to 3, Exemplary Examples 1 to 7 have more excellent elongation (2.5% to 3.6% in Exemplary Examples, and 1.9% to 2.3% in Comparative Examples) and impact strength (i.e. toughness), especially in terms of the impact strength at low temperature (for CHARPY KJ/m² (23° C.), the Exemplary Examples are 37.6 to 54.5 KJ/m², the Comparative Examples are 12.2 KJ/m² to 16.1 KJ/m²; for CHARPY KJ/m² (−40° C.), the Exemplary Examples are 32.1 KJ/m² to 53.7 KJ/m², and the Comparative Examples are 2.1 KJ/m² to 3.5 KJ/m²).

In addition, during the manufacturing process, compared with Comparative Examples 1 to 3, Exemplary Examples 1 to 7 have better impregnating effect of melt-mixed raw materials on glass fibers, thereby improving the problem of poor impregnating effect in the related art.

### Beneficial Effects of the Embodiments

In conclusion, in the polyamide-long glass fiber reinforced composite material and the method for producing the same provided by the present disclosure, by virtue of “the toughener being an elastomer composed of a first polyolefin material and modified by maleic anhydride, the compatibilizer being a resin material composed of a second polyolefin material and modified by the maleic anhydride, and a first melt flow index of the toughener being less than a second melt flow index of the compatibilizer,” and “the long glass fiber being fully impregnated by the mixed plastic melt, and a surface of the long glass fiber being modified by at least one of a hydroxyl group and a carboxyl group,” the toughness of the polyamide resin (i.e., nylon plastic) can be effectively improved, and the poor impregnating effect during the manufacturing process can also be effectively improved.

Furthermore, the polyamide-long glass fiber reinforced composite material of the embodiment of the present disclosure can have excellent heat resistance, stiffness, mechanical strength, chemical resistance, and surface gloss, and has low water absorption and good dimensional stability. The polyamide-long glass fiber reinforced composite material of the embodiment of the present disclosure can be widely used in the fields of electronic appliances, automobiles, military industries, and the like.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a polyamide-long glass fiber reinforced composite material, comprising:
performing a feeding step, which includes feeding raw materials into an extruder, and mixing and melting the raw materials to form a mixed plastic melt; wherein the raw materials include: a polyamide resin, a toughener, and a compatibilizer; wherein the toughener is an elastomer composed of a first polyolefin material and modified by maleic anhydride, the compatibilizer is a resin material composed of a second polyolefin material and modified by the maleic anhydride, and a first melt flow index of the toughener is less than a second melt flow index of the compatibilizer;
performing an impregnating step, which includes conveying the mixed plastic melt into an impregnating device, and conveying a long glass fiber in a continuous form into the impregnating device, so that the long glass fiber is fully impregnated by the mixed plastic melt; wherein a surface of the long glass fiber is modified by at least one of a hydroxyl group and a carboxyl group; and
performing a shaping step, which includes shaping, cooling, and pelletizing the long glass fiber impregnated by the mixed plastic melt to obtain the polyamide-long glass fiber reinforced composite material.

2. The method for producing the polyamide-long glass fiber reinforced composite material according to claim 1, wherein the extruder is a twin-screw extruder, a processing temperature of the extruder is between 250° C. and 400° C., and a screw rotation speed of the extruder is between 200 rpm and 300 rpm.

3. The method for producing the polyamide-long glass fiber reinforced composite material according to claim 1, wherein the first polyolefin material of the toughener is at least one material selected from the group consisting of ethylene-propylene diene monomer (EPDM) rubber, thermoplastic polyolefin (TPO), polyolefin elastomer (POE), and ethylene-methyl acrylate-glycidyl methacrylate (E-MA-GMA) terpolymer.

4. The method for producing the polyamide-long glass fiber reinforced composite material according to claim 3, wherein a first maleic anhydride graft ratio of the toughener is between 0.3% and 1.5%, and the first melt flow index of the toughener is between 1 g/10 min and 20 g/10 min.

5. The method for producing the polyamide-long glass fiber reinforced composite material according to claim 4, wherein the second polyolefin material of the compatibilizer is at least one material selected from the group consisting of polyethylene (PE), polypropylene (PP), and ethylene-propylene copolymer.

6. The method for producing the polyamide-long glass fiber reinforced composite material according to claim 5, wherein a second maleic anhydride graft ratio of the compatibilizer is between 0.3% and 1.5%, and the second melt flow index of the toughener is between 100 g/10 min and 600 g/10 min.

7. The method for producing the polyamide-long glass fiber reinforced composite material according to claim 6, wherein, when the toughener, the compatibilizer, and the polyamide resin are mixed and melted in the extruder, an active anhydride group of the maleic anhydride modified on the toughener or the compatibilizer is capable of reacting with an amino functional group at an end of a polymer chain of the polyamide resin to initially form an amide bond, and then form an imide bond after a ring-closing reaction, so that a graft copolymer is finally formed.

8. The method for producing the polyamide-long glass fiber reinforced composite material according to claim 1, wherein the raw materials further include a flow modifier, and the flow modifier is a polyolefin type hyper-dispersant having a number average molecular weight of between 1,000 g/mol and 10,000 g/mol.

9. The method for producing the polyamide-long glass fiber reinforced composite material according to claim 1, wherein, in the impregnating step, the long glass fiber is conveyed to a spreading device through a bobbin device, and the long glass fiber is introduced into the impregnating device after a preheating operation and a spreading operation, so that the long glass fiber in a preheated and spread state is impregnated by the mixed plastic melt.

10. The method for producing the polyamide-long glass fiber reinforced composite material according to claim 9, wherein the long glass fiber impregnated by the mixed plastic melt is capable of being outputted from the impregnating device after being bundled and covered by a die head of the impregnating device; wherein the long glass fiber is a glass fiber having a length of between 5 millimeters and 30 millimeters.

11. A polyamide-long glass fiber reinforced composite material, comprising:
an impregnating material including a polyamide resin, a toughener, and a compatibilizer; wherein the toughener is an elastomer composed of a first polyolefin material and modified by maleic anhydride, the compatibilizer is a resin material composed of a second polyolefin material and modified by the maleic anhydride, and a first melt flow index of the toughener is less than a second melt flow index of the compatibilizer; and
a glass fiber material being impregnated and covered by the impregnating material; wherein the glass fiber material includes a long glass fiber, and a surface of the long glass fiber is modified by at least one of a hydroxyl group and a carboxyl group.

12. The polyamide-long glass fiber reinforced composite material according to claim 11, wherein the first polyolefin material of the toughener is at least one material selected from the group consisting of ethylene-propylene diene monomer (EPDM) rubber, thermoplastic polyolefin (TPO), polyolefin elastomer (POE), and ethylene-methyl acrylate-glycidyl methacrylate (E-MA-GMA) terpolymer; wherein a first maleic anhydride graft ratio of the toughener is between 0.3% and 1.5%, and the first melt flow index of the toughener is between 1 g/10 min and 20 g/10 min.

13. The polyamide-long glass fiber reinforced composite material according to claim 12, wherein the second polyolefin material of the compatibilizer is at least one material selected from the group consisting of polyethylene (PE), polypropylene (PP), and ethylene-propylene copolymer; wherein a second maleic anhydride graft ratio of the compatibilizer is between 0.3% and 1.5%, and the second melt flow index of the toughener is between 100 g/10 min and 600 g/10 min.

14. The polyamide-long glass fiber reinforced composite material according to claim 13, wherein the impregnating material further incudes a flow modifier, and the flow modifier is a polyolefin type hyper-dispersant having a number average molecular weight of between 1,000 g/mol and 10,000 g/mol.

15. The polyamide-long glass fiber reinforced composite material according to claim 14, wherein, based on a total weight of the impregnating material being 100 parts by weight, a content of the polyamide resin is between 50 parts by weight and 97 parts by weight, a content of the toughener is between 0.1 parts by weight and 20 parts by weight, a content of the compatibilizer is between 0.1 parts by weight and 20 parts by weight, and a content of the flow modifier is not greater than 10 parts by weight.

16. The polyamide-long glass fiber reinforced composite material according to claim 15, wherein a weight ratio of the glass fiber material to the impregnating material ranges from 5:95 to 65:35.
